(19) United States
(12) Patent Application Publication
(10) Pub. No.: US 2026/0181230 A1
(43) Pub. Date: Jun. 25, 2026

(54) IMAGING APPARATUS AND ELASTIC DUSTPROOF MEMBER USED IN SAME

(71) Applicant: DENSO CORPORATION, Kariya-city (JP)

(72) Inventor: Kiwako TAKEZAWA, Kariya-city (JP)

(21) Appl. No.: 19/425,183

(22) Filed: Dec. 18, 2025

(30) Foreign Application Priority Data
Dec. 23, 2024 (JP) 2024-226365

(51) Int. Cl. H04N 23/52; G03B 17/12; G03B 30/00; H04N 23/51; H04N 23/54; H04N 23/57

(52) U.S. Cl. CPC H04N 23/52; G03B 17/12; G03B 30/00; H04N 23/51; H04N 23/54; H04N 23/57

(57) ABSTRACT

An imaging device includes an elastic dustproof member disposed between a base portion of a case and a substrate on which an imager is mounted. The elastic dustproof member 50 includes a first frame placed in contact with the base portion, a second frame placed in contact with the substrate, and a flexible portion connecting with the first and second frames. The flexible portion is elastically deformable to change an interval between the first and second frames. Dimensions of the first and second frames in directions, which are perpendicular both to the center line of a cylindrical portion of a lens barrel which defines an inner wall and to extending directions of the first and second frames, are defined as a first width dimension and a second width dimension, respectively. The second width dimension is smaller than the first width dimension.

### CROSS REFERENCE TO RELATED DOCUMENT

The present application claims the benefit of priority of Japanese Patent Application No. 2024-226365 filed on Dec. 23, 2024, the disclosure of which is incorporated in its entirety herein by reference.

### TECHNICAL FIELD

This disclosure relates generally to an imaging apparatus installed in a vehicle and an elastic dustproof member used with the imaging apparatus.

### BACKGROUND ART

An imaging device is known that includes a lens barrel which has a lens disposed therein, a circuit substrate on which an imager is mounted, and a case that holds the circuit substrate. The imaging device works to capture a subject image, which is input through the lens, by means of the imager, and outputs it as an image signal. However, when foreign matter adheres to the imager or related components, an accurate image signal cannot be obtained. Japanese Patent First Publication No. 2021-92682 discloses a technique in which a dustproof rubber member is provided between the circuit substrate and the lens. The rubber has a thick portion on the circuit substrate, where the imager is mounted, and a thin portion on the lens, thereby preventing foreign matter from adhering to the imager.

However, various electronic components are mounted on the circuit substrate on which the imager is implemented, and it is necessary to mount these components with a sufficient gap so as not to interfere with the dustproof rubber. Therefore, when using the dustproof rubber having the thick portion on the circuit substrate, as disclosed in the above Japanese Patent publication, a wide gap must be provided to accommodate the thick portion. This, in turn, leads to an increase in size of the circuit substrate, resulting in an overall increase in size of the imaging device and consequently in the product cost.

### SUMMARY

It is an object of this disclosure to provide an imaging device which has a circuit structure capable of suppressing an increase in size, and to an elastic dustproof member used therein.

According to one aspect of this disclosure, there is provided an imaging device for installation in a vehicle which comprises a camera module (10) which includes (a) a lens barrel (20), a substrate (30), a case (40), and an elastic dustproof member (50). The lens barrel includes a main body (21) in which a lens (LS) is disposed and a protrusion (22) which is formed on an outer periphery of the main body and protrudes away from a center of the lens. The main body has formed therein a through-hole (213) through which light, as passing through the lens, travels. The substrate (30) has an imager (31) mounted thereon. The case (40) has formed therein a hole (411) in which the main body of the lens barrel is disposed. The case includes a base portion (41) to which the protrusion of the lens barrel is secured around the main body and the insertion hole. The case defines a housing chamber (54) in which the substrate is retained. The elastic dustproof member (50) is arranged between the base portion and the substrate and isolates a first space (54a), which is defined within the housing chamber and in which the imager and the through-hole are located, from a second space (54b) which is defined outside the first space. The elastic dustproof member has a cylindrical shape and includes a first frame (51), a second frame (52), and a flexible portion (53). The first frame is located closer to the base portion than the second frame is. The second frame is placed in contact with the substrate. The flexible portion connects with the first frame and the second frame and is elastically deformable to change an interval between the first frame and the second frame. The center line of a cylindrical portion of the lens barrel which constitutes an inner wall is defined as a central axis (CL). Dimensions of the first frame and the second frame in directions, which are perpendicular both to the central axis and to extending directions of the first frame and the second frame, are defined as a first width dimension (W1) and a second width dimension (W2), respectively. The second width dimension is smaller than the first width dimension.

Accordingly, since the elastic dustproof member is provided with the flexible portion so as to have a flexible or bendable structure, even when the elastic dustproof member deforms between the base portion and the substrate, the bendable structure elastically expands or contracts, thereby suppressing undesirable elastic deformation of the first frame and the second frame. This enables the contact area between the second frame and the substrate to be minimized. In addition, the width dimension of the first frame is selected to be larger than that of the second frame, thereby ensuring the stability in contact of the first frame with the base portion, which results in reliable contact between the second frame and the substrate even though the contact area therebetween is small. Furthermore, because the width dimension of the second frame that is placed in contact with the substrate is made small, the gap required for contact between the second frame and the substrate may be reduced. Accordingly, it becomes easier to secure a space for arranging electronic components on the substrate, thereby suppressing an increase in the size of the substrate, and consequently suppressing an increase in the size of the imaging device.

According to the second aspect of this disclosure, there is provided an elastic dustproof member for use with an imaging device installed in a vehicle which comprises: (a) a first frame (51) which is located at a first end portion of a cylindrical shape of the elastic dustproof member; (b) a second frame (52) which is located at a second end portion of the cylindrical shape of the elastic dustproof member; and (c) a flexible portion (53) which connects with the first frame and the second frame and is elastically deformable to change an interval between the first frame and the second frame. Dimensions of the first frame and the second frame in directions, which are perpendicular both to an expansion/contraction direction of the flexible portion and to extending directions of the first frame and the second frame, are defined as a first width dimension (W1) and a second width dimension (W2), respectively. The second width dimension is smaller than the first width dimension.

Use of the above-described structure of the elastic dustproof member with the imaging device offers the beneficial advantages as provided by the above-described first aspect of this disclosure.

It should be noted that the reference numerals in parentheses appended to respective structural elements indicate merely one example of correspondence between those structural elements and the specific constituent elements described in embodiments to be described later.

### BRIEF DESCRIPTION OF THE DRAWINGS

The present disclosure will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a schematic view which illustrates a configuration of an imaging device according to a first embodiment;

FIG. 2 is a cross-sectional view which illustrates a camera module in the imaging device illustrated in FIG. 1;

FIG. 3 is an enlarged cross-sectional view of a camera module;

FIG. 4A is a plan view of an elastic dustproof member;

FIG. 4B is a side view of an elastic dustproof member;

FIG. 5 is a comparative view showing a first state before contraction of a flexible portion and a second state after contraction of the flexible portion;

FIG. 6 is a comparative view showing a first state before contraction of the flexible portion and a state 2 after contraction thereof.

FIG. 7 is an enlarged cross-sectional view of a camera module according to a second embodiment;

FIG. 8 is a plan view of an elastic dustproof member according to a third embodiment;

FIG. 9 is a cross-sectional view of an elastic dustproof member according to a fourth embodiment;

FIG. 10A is a cross-sectional view of an elastic dustproof member described in another embodiment;

FIG. 10B is a cross-sectional view of an elastic dustproof member described in another embodiment; and

FIG. 10C is a cross-sectional view of an elastic dustproof member described in another embodiment.

### MODES FOR CARRYING OUT THE INVENTION

In the following embodiments, when only a part of structural elements are referred to, the other parts of the structural elements may employ the configurations described in the preceding embodiments. Furthermore, the following embodiments may be partially combined with each other within a range in which no hindrance arises from such combination, even if the combination is not explicitly stated.

### First Embodiment

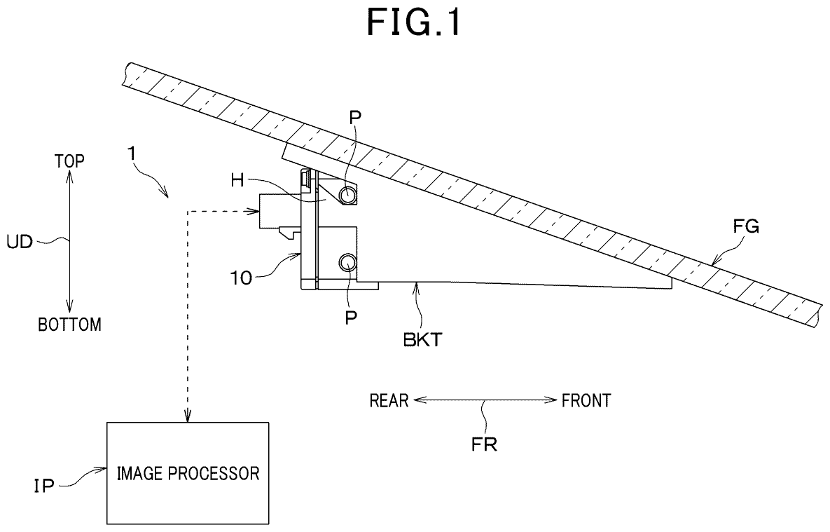

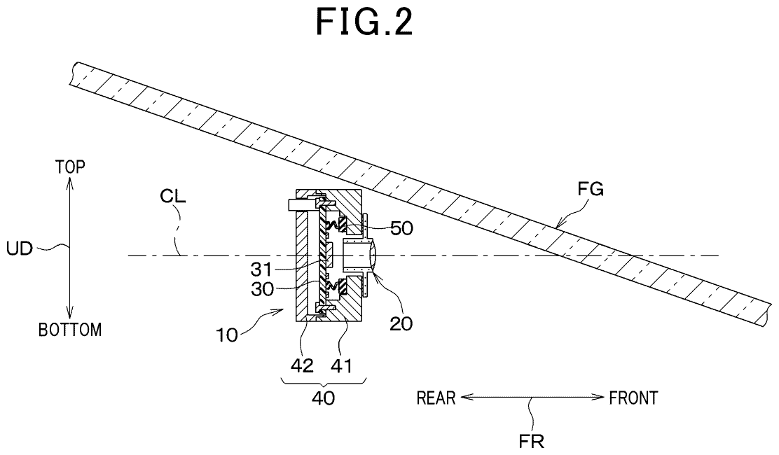

The present embodiment will be described with reference to FIGS. 1 to 6. As shown in FIGS. 1 and 2, the imaging device 1 is mounted on a vehicle and configured to capture images of an area outside the vehicle. In this embodiment, the imaging device 1 is implemented as a forward monitoring camera that captures images of a region in front of the vehicle. Arrows indicating vertical and longitudinal directions in FIGS. 1 and 2 represent a vertical direction UD and a front-rear direction FR, respectively, in a state where the imaging device 1 is mounted on the vehicle. Furthermore, a direction perpendicular to the plane of the drawing represents a lateral direction.

The imaging device 1 includes the camera module 10, the bracket BKT, and the image processor IP. As shown in FIG. 1, the imaging device 1 is configured such that the camera module 10 and the image processor IP are formed as discrete units.

The bracket BKT works to position the camera module 10 near the front glass or windshield FG of the vehicle and is fixed to the windshield FG. The bracket BKT includes a substantially L-shaped hook H for mounting the camera module 10. The camera module 10 is mounted close to the windshield FG by engaging a cylindrical mounting pin P, provided on the outer surface of the camera module 10, with the hook H of the bracket BKT.

The image processor IP is a device that processes image signals output from the camera module 10, and implemented by a microcomputer including a processor and a memory. The image processor IP performs, for example, a recognition task for identifying lanes, road shapes, obstacles, traffic signs, and the like using images captured by the camera module 10, and executes a target route generating task and a vehicle control task based on results of the recognition task. The image processor IP is connected to the camera module 10 via a communication line. It should be noted that the image processor IP may alternatively be connected to the camera module 10 wirelessly.

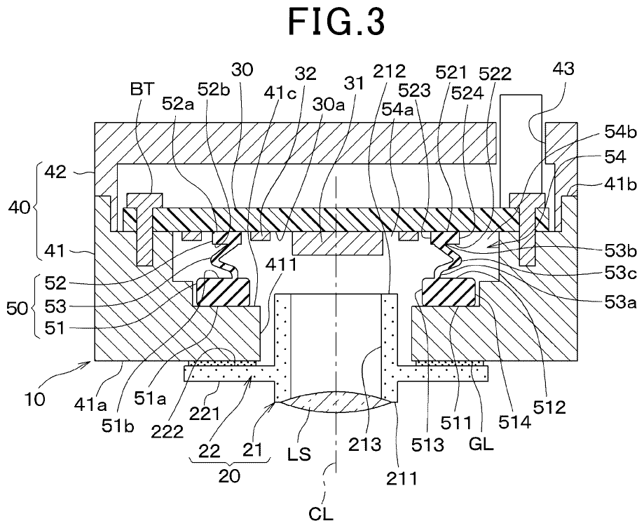

Next, the camera module 10 will be described. As shown in FIGS. 2 and 3, the camera module 10 is configured as a fixed-focus type monocular camera in which the distance between the lens LS and the imager 31, which will be described later in detail, is fixed to be constant. The camera module 10 includes the lens barrel 20 in which the lens LS is accommodated, the substrate 30 on which the imager 31 is mounted, the case 40 that holds the substrate 30, and the elastic dustproof member 50 that is disposed between the substrate 30 and the case 40.

The lens barrel 20 is located close to the windshield FG of the vehicle. The lens barrel 20 includes the lens LS, the main body 21 in which the lens LS is disposed, and the flange 22 defined by a protrusion formed on an outer periphery of the main body 21. The main body 21 and the flange 22 are made of a resin material such as PPS resin. The main body 21 and the flange 22 are formed integrally as a one-piece molded product.

The main body 21 is a substantially cylindrical member. Although not shown in the drawings, the through hole 213 for transmitting light is formed inside the main body 21. The lens LS is disposed in the through hole 213 of the main body 21 with an optical axis thereof coinciding with the central axis CL of the lens barrel 20. The central axis CL of the lens barrel 20 coincides with the center line of a cylindrical portion of the lens barrel 20 which defines an inner wall on which the lens LS is mounted. Although only the lens LS is illustrated here as an optical system, it is sufficient that at least one lens LS be provided, however, a plurality of lenses LS may also be used. When a plurality of lenses LS are used, the optical axes of the respective lenses LS are aligned with each other and disposed within the through hole 213.

The flange 22 is formed on an outer peripheral surface of the main body 21 and projects in a direction away from the central axis CL of the lens barrel 20. The flange 22 extends annularly in a direction substantially perpendicular to the central axis CL. Specifically, the flange 22 is located intermediate between the front end 211 and the rear end 212 of the main body 21. The flange 22 has the front surface 221 facing the front end 211 and the rear surface 222 facing the rear end 212 away from the front surface 221. The rear surface 222 of the flange 22 is adhered to the case 40 via, for example, the adhesive GL, whereby the lens barrel 20 is fixed to the case 40. A portion of the lens barrel 20, which is located closer to the rear end 212 than the flange 22 is, is arranged inside the case 40, while the flange 22 and a portion of the lens barrel 20, which is located closer to the front end 211 than the flange 22 is, is exposed outside the case 40.

The substrate 30 is a circuit board on which a wiring pattern is formed and on which devices including the imager 31 are mounted. The imager 31 is mounted on the surface 30a of the substrate 30, which serves as a front surface facing the lens LS. In addition, a plurality of electronic components 32 and wiring patterns (not shown) are mounted on portions of the surface 30a that are located around the imager 31. The substrate 30 is held by the case 40 through fasteners, such as the bolts BT.

The imager 31 is made of a semiconductor device such as a CCD (Charge Coupled Device) image sensor or a CMOS (Complementary Metal Oxide Semiconductor) image sensor. The imager 31 works to capture a subject image formed on its light-receiving surface by the lens LS and outputs an image signal. The imager 31 is fixed to the substrate 30 by means such as soldering. Specifically, the imager 31 is mounted on a portion of the substrate 30 that faces the lens LS so that light transmitted through the lens LS enters the imager 31.

The case 40 is a box-shaped member made of metal or resin. As shown in FIG. 1, a plurality of mounting pins P for engagement with the hook H of the bracket BKT are provided on an outer surface of the case 40. As shown in FIGS. 2 and 3, the case 40 includes the base portion 41 and the lid portion 42 connected to the base portion 41.

The base portion 41 is a component to which the lens barrel 20, on which the lens LS is mounted, is fixed. The base portion 41 has the insertion hole 411 that extends in the front-rear (FR) direction. The flange 22 is fixed to the base portion 41 while a part of the main body 21 of the lens barrel 20 is inserted through the insertion hole 411, thereby fixing the lens barrel 20 to the case 40 so as to surround the entire periphery of the main body 21 and the through hole 213. The positions of the insertion hole 411 and the substrate 30 are set so that the optical axis of the lens barrel 20 disposed in the insertion hole 411 coincides with the center of the imager 31. The base portion 41 has the front end surface 41a which faces the lens LS, and the rear end surface 41b connected to the lid portion 42. The rear end surface 41b has a stepped shape in which an inner portion thereof is recessed relative to an outer edge thereof, and the seating surface 41c is formed which surrounds the periphery of the lens barrel 20. The seating surface 41c, on which the elastic dustproof member 50 is disposed, is formed in the shape of a flat surface.

It is to be noted that, although the rear end surface 41b has been described as having a stepped shape in which the inner portion is recessed relative to the outer edge thereof, the rear end surface 41b may alternatively be formed as a simple flat surface or as a stepped shape in which the inner portion protrudes relative to the outer edge. Similarly, although the front end surface 41a is configured as a flat surface, a portion of the front end surface 41a around the lens LS may be formed in a shape that projects outward from the outer edge in a circular or polygonal form contoured along the lens LS.

The lid portion 42 is connected to the base portion 41 by fasteners (not shown). The lid portion 42 has an external shape corresponding to that of the base portion 41, and defines the housing chamber 54 in which the substrate 30 is disposed between the lid portion 42 and the base portion 41. The lid portion 42 has formed therein the opening 43 through which communication lines extend outside the lid portion 42.

It is to be noted that the case 40 and the lens barrel 20 are placed in close contact with each other through the adhesive GL. For example, during the manufacturing of the camera module 10, the adhesive GL is applied to the front end surface 41a of the base portion 41 in an annular shape, after which the rear end surface 222 of the flange 22 of the lens barrel 20 is attached to the front end surface 41a, thereby bonding the lens barrel 20 to the case 40. As the adhesive GL, a material having thermosetting properties is employed; however, another material having no thermosetting properties may alternatively be used.

The elastic dustproof member 50 is disposed between the base portion 41 and the substrate 30. The elastic dustproof member 50 defines a partition wall that separates the first space 54a, in which the through hole 213 of the lens barrel 20 and the imager 31 are disposed, from the second space 54b within the housing chamber 54 of the case 40, thereby minimizing a risk of entry of foreign matter into the space 54a. In the present embodiment, the elastic dustproof member 50 is configured as a dustproof rubber made of a rubber material; however, it may alternatively be made of another elastic material such as a foamed material like a sponge. As the rubber material, for example, silicone rubber, nitrile rubber, or fluororubber may be used, and as the foamed material, polyurethane, polyethylene, or polypropylene may be applied.

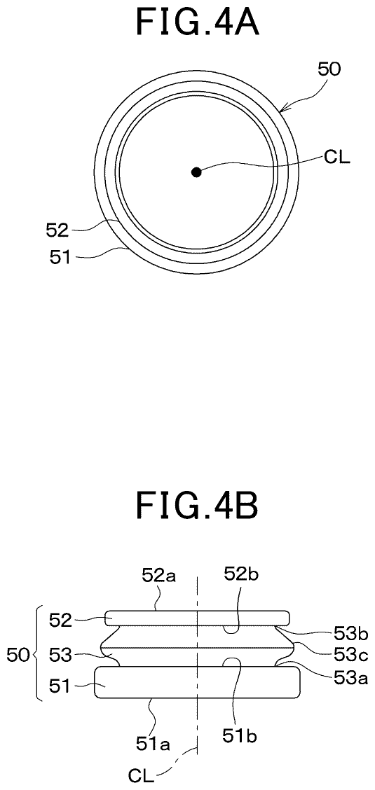

As shown in FIGS. 4A and 4B, the elastic dustproof member 50 has a cylindrical shape. In the present embodiment, the elastic dustproof member 50 is configured in an annular planar shape when viewed in the front-rear (FR) direction, and is generally formed in a cylindrical shape although its outer diameter and inner diameter vary along the central axis CL. Specifically, the elastic dustproof member 50 includes the first frame 51 having the first contact surface 51a which is placed in physical contact with the base portion 41 and the second frame 52 having the second contact surface 52a placed in physical contact with the substrate 30, and the flexible portion 53 disposed between the first frame 51 and the second frame 52.

The shapes and dimensions of the first frame 51 and the second frame 52 are set as follows. Hereinafter, with respect to the dimensions of portions of each of the first frame 51 and the second frame 52, a dimension along the central axis CL of the lens barrel 20 is referred to as a height dimension, and a dimension perpendicular both to the central axis CL (which coincides with an expansion or contraction direction of the elastic dustproof member 50) and to the extending direction of a corresponding one of the first frame 51 and the second frame 52 is referred to as a width dimension. In a case where a planar shape of the elastic dustproof member 50 is an annular form, the extending direction of the elastic dustproof member 50 i.e., a direction in which the elastic dustproof member 50 is defined as coinciding with the circumferential direction of the elastic dustproof member 50, and the width dimension is defined as coinciding with a radial dimension of the elastic dustproof member 50 centered on the central axis CL. Alternatively, in a case where each of the first frame 51 and the second frame 52 has a planar shape that is not annular, for example, a shape including a linear portion, the extending direction of each of the first frame 51 and the second frame 52 coincides with the length direction (also called a linear direction) of the linear portion, and the width dimension corresponds to a dimension perpendicular to both the linear direction and the central axis CL.

As shown in FIG. 3, the first frame 51 and the second frame 52 each have a cross-sectional shape, taken along a plane normal to their extending direction—which, in the present embodiment, corresponds to the radial direction—that is a quadrilateral shape with rounded corners. More specifically, in this cross section, the first frame 51 has a rectangular shape in which two long sides are composed of the first edge 511 forming the first contact surface 51a and the second edge 512, and two short sides 513 and 514 are located between the two long sides and face away from each other. Similarly, in the cross section, the second frame 52 has a rectangular shape in which two long sides are composed of the first edge 521 forming the second contact surface 52a and the second edge 522, and two short sides 523 and 524 are located between the two long sides and face away from each other.

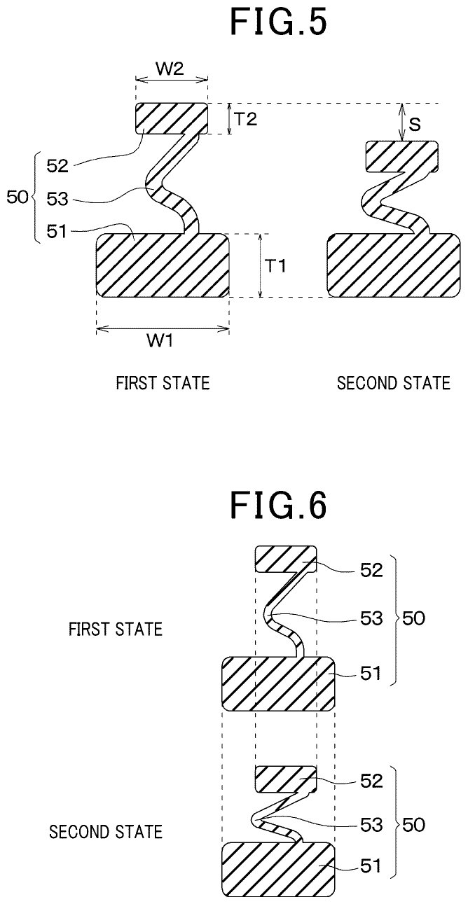

As shown in FIG. 5, the width dimension W1 of the first frame 51, which will also be referred to below as a first width dimension, is made larger than the width dimension W2 of the second frame 52, which will also be referred to below as a second width dimension. In addition, the height dimension T1 of the first frame 51 is made larger than the height dimension T2 of the second frame 52. Since the first frame 51 has the larger width dimension W1 and height dimension T1, the contact area with the base portion 41 is also larger, and the first frame 51 is less likely to deform, thereby maintaining a stable contact state with the base portion 41 without tilting. Although the second frame 52 has the smaller width dimension W2 and height dimension T2 than those of the first frame 51, and therefore has a smaller contact area with the substrate 30 and is slightly more likely to deform, it can still maintain contact with the substrate 30 because the first frame 51 provides a stable contact state. In addition, in the present embodiment, since the dimensions of the second frame 52 are set as described below, the contact state with the substrate 30 can be further stabilized.

In order to achieve stable contact of the second frame 52 with the substrate 30 without inclination, it is preferable that the width dimension W2 be set to a certain magnitude. As a result of intensive studies, it has been confirmed that the width dimension W2 that allows the second frame 52 to be stably brought into contact with the substrate 30 is related to an amount of deflection of the flexible portion 53, which will be described later and referred to below as a deflection amount S, and that satisfactory stability can be obtained when the ratio S/W2 of the deflection amount S to the width dimension W2 is 2 or less. Accordingly, since the difference in the height dimension of the elastic dustproof member 50 before and after the elastic dustproof member 50 is installed between the base portion 41 and the substrate 30 corresponds to the deflection amount S, the maximum value of this difference, taking into account manufacturing variations, is assumed as the deflection amount S, and the width dimension W2 is set to be equal to or greater than one-half of the deflection amount S. Although a larger width dimension W2 contributes to more stable contact between the second frame 52 and the substrate 30, an excessively large width dimension W2 may cause an increase in the size of the substrate 30; therefore, it is preferable that the width dimension W2 be set to not more than twice the deflection amount S.

The height dimension T2 of the second frame 52 is optional; however, it is preferable that the second frame 52 be less deformable so that the second frame 52 can be brought into more stable contact with the substrate 30. In the present embodiment, in which the cross-sectional shape of the second frame 52 is configured to be rectangular, stable contact between the second frame 52 and the substrate 30 can be achieved when the ratio S/T2 of the deflection amount S to the height dimension T2 is 2 or less.

It is to be noted that the width dimensions W1 and W2 represent maximum dimensions of the first frame 51 and the second frame 52, respectively, in a cross section taken along a plane normal to the extending directions of the first frame 51 and the second frame 52. Accordingly, when the cross-sectional shapes of the first frame 51 and the second frame 52 are quadrilateral shapes with rounded corners, the actual width dimensions of the edge 511 and the edge 521 are slightly smaller than the width dimensions W1 and W2, respectively. However, the width dimensions of the edge 511 and the edge 521 may be regarded as equivalent to the width dimensions W1 and W2, respectively. Therefore, it can be said that the width dimension of the edge 511 is larger than that of the edge 521. In addition, the area of the first contact surface 51a can be said to be larger than that of the second contact surface 52a.

The flexible portion 53 is, as can be seen in FIG. 3, a portion of the elastic dustproof member 50 which has a deflectable structure. The flexible portion 53 is connected to a portion of the first frame 51 that constitutes the surface 51b, that is, the edge 512, which faces the first contact surface 51a, and to a portion of the second frame 52 that constitutes a surface 52b, that is, the edge 522, which faces the second contact surface 52a. The flexible portion 53 is thinner and more flexible than the first frame 51 and the second frame 52, and capable of expanding or contracting in the direction of the central axis CL to change the distance between the first frame 51 and the second frame 52. The elastic dustproof member 50 disposed between the base portion 41 and the substrate 30, therefore, functions to compress the flexible portion 53, thereby ensuring the stability in physical contact between the first contact surface 51a and the base portion 41, and between the second contact surface 52a and the substrate 30.

As can be seen in FIG. 3, the flexible portion 53 has a wavy shape in which a cross section thereof, as taken in the radial direction, between the connecting portion 53a leading to the first frame 51 and the connecting portion 53b leading to the second frame 52 is formed in a V-shape. This configuration results in a decrease in reaction force, as generated by the flexible portion 53, when the flexible portion 53 is compressed. In addition, the intermediate portion 53c between the connecting portion 53a and the connecting portion 53b is bent so as to bulge outward in the radial direction with respect to the central axis CL. Therefore, as shown in first and second states of FIG. 6, even when the flexible portion 53 expands or contracts, the intermediate portion 53c is deformed outward in the radial direction, thereby preventing the flexible portion 53 from protruding toward the space 54a extending from the lens barrel 20 to the imager 31.

The imaging device 1 is, as described above, equipped with the elastic dustproof member 50 between the base portion 41 and the substrate 30. The elastic dustproof member 50 serves to isolate the space 54a, in which the through hole 213 of the lens barrel 20 and the imager 31 are disposed, from the outer space 54b, thereby eliminating the risk of foreign substances adhering to the imager 31. This improves the accuracy of the image signal which represents an image of a subject captured by the imager 31. In addition, since the flange 22 of the lens barrel 20 and the base portion 41 are closely bonded together with the adhesive GL, it is unlikely that foreign substances will enter through the interface therebetween. Therefore, if any foreign matter enters, it is likely to occur through a gap between the base portion 41 and the lid portion 42 or through the opening 43. Consequently, by disposing the elastic dustproof member 50 so as to surround the periphery of the imager 31, adhesion of foreign substances to the imager 31 and the like can be effectively prevented.

Furthermore, since the elastic dustproof member 50 is equipped with the flexible portion 53 which has a deflectable structure, even when the elastic dustproof member 50 is deformed between the base portion 41 and the substrate 30, the deflectable structure expands or contracts, thereby suppressing deformation of the first frame 51 and the second frame 52. This enables the contact area between the second frame 52 and the substrate 30 to be minimized.

In addition, the width dimension W1 of the first frame 51 is made larger than the width dimension W2 of the second frame 52, thereby ensuring the stability in contact between the first frame 51 and the base portion 41 and between the second frame 52 and the substrate 30 even when the contact area therebetween is small. Moreover, the width dimension W2 of the second frame 52, which is brought into contact with the substrate 30, is selected to be small, which results in a decreased gap required for achieving the contact between the second frame 52 and the substrate 30. Accordingly, it becomes easier to secure a space for arranging the electronic components 32 on the substrate 30, whereby enlargement of the substrate 30 can be suppressed. Consequently, the overall size of the imaging device 1 can be reduced, and the product cost can be lowered.

Furthermore, even though the width dimension W2 of the second frame 52 is made smaller, it is set to be equal to or greater than one-half of the deflection amount S, thereby allowing the contact state between the second frame 52 and the substrate 30 to be more reliably maintained.

In the production process of the camera module 10, the elastic dustproof member 50 is disposed on the base portion 41 of the case 40, and then the substrate 30 is fixed to the base portion 41 using fasteners such as the bolt BT. This causes the second frame 52 of the elastic dustproof member 50 to be placed in contact with the substrate 30 while maintaining a stable contact state in which the first frame 51, having a larger contact area than that of the second frame 52, is disposed in stable contact with the base portion 41, thereby minimizing misalignment of the elastic dustproof member 50 even when the flexible portion 53 is deflected.

### Second Embodiment

The second embodiment will be described below which is different from the first embodiment in that the connection structure between the lens barrel 20 and the base portion 41 is modified, while other configurations are the same as those of the first embodiment. Therefore, only portions that differ from the first embodiment will be described hereinafter.

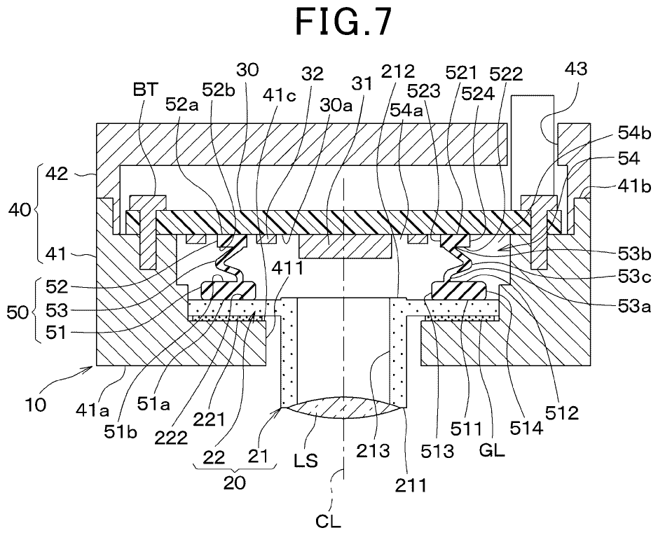

The camera module 10 according to the second embodiment is, as illustrated in FIG. 7, configured such that the flange 22 of the lens barrel 20 is located inside the case 40, and the front end surface 221 of the flange 22 is bonded to the seating surface 41c of the base portion 41 with the adhesive GL.

The flange 22 has the rear end surface 222 serving as a seating surface. The first frame 51 of the elastic dustproof member 50 has the first contact surface 51a placed in contact with the rear end surface 222 of the flange 22. Even in a case where the portion contacted by the first frame 51 is the flange 22 rather than the base portion 41, effects similar to those of the first embodiment are obtained.

### Third Embodiment

The third embodiment will be described below. In this embodiment, the shape of the elastic dustproof member 50 is modified compared to the first and second embodiments. Since other aspects are the same as in the first and second embodiments, only the portions that differ from the first and second embodiments will be described.

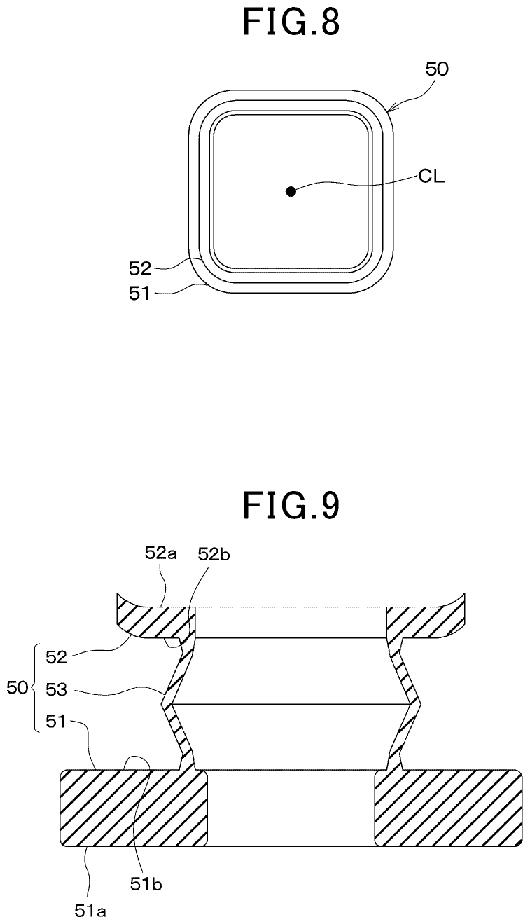

As shown in FIG. 8, the planar shape of the elastic dustproof member 50, when viewed in the front-rear direction (FR), is quadrangular, and more specifically, a quadrangular shape with rounded corners. In other words, the elastic dustproof member 50 is formed in a generally quadrangular tubular shape. Even when the elastic dustproof member 50 has such a shape, effects similar to those of the first and second embodiments are obtained. Furthermore, when the elastic dustproof member 50 is arranged with each side of the quadrangular shape thereof extending along a corresponding side of the quadrangular shape of the imager 31, the second frame 52 may simply be disposed in a gap between the elastic dustproof member 50 and the imager 31, thereby minimizing the installation space required for the second frame 52.

The planar shape of the elastic dustproof member 50 in this embodiment, when viewed in the front-rear direction (FR), is a shape other than circular. Accordingly, the width and height dimensions of a cross section taken along a direction normal to each side of the quadrangular shape of the elastic dustproof member 50 are defined as width dimensions W1 and W2 and height dimensions T1 and T2, respectively.

### Fourth Embodiment

The fourth embodiment will be described below. In this embodiment, the shape of the elastic dustproof member 50 is modified relative to the first and second embodiments. Since other aspects are the same as in the first and second embodiments, only portions that differ from the first and second embodiments will be described.

As shown in FIG. 9, the shape of the second frame 52 of the elastic dustproof member 50 is different from that in the first embodiment. Specifically, an outer peripheral portion of the second frame 52 is formed with a curvature directed away from the first frame 51, as compared with its inner peripheral portion. In other words, the second contact surface 52a of the second frame 52 is oriented to extend gradually away from the flexible portion 53 toward the outer peripherally of the second frame 52 from the central axis CL.

As apparent from the above discussion, a sufficient degree of contact between the second frame 52 and the substrate 30 is ensured by increasing the width dimension W1 of the first frame 51 even when the width dimension W2 of the second frame 52 is decreased. This, however, may lead to a risk that the second frame 52 may become inclined with respect to the central axis CL, resulting in a reduction of the contact area of the second frame 52 with the substrate 30. The elastic dustproof member 50 in this embodiment is, as described above, designed to have the second frame 52 whose outer periphery is curved away from the first frame 51, thereby ensuring a sufficient contact area between the second frame 52 and the substrate 30.

### Other Embodiments

The present disclosure has been described based on the embodiments set forth above; however, it is not limited to those embodiments, and various modifications, alternatives, and equivalents are also encompassed within the scope of the disclosure. In addition, various combinations and configurations, as well as other arrangements including only one element, multiple elements, or fewer elements than those described, also fall within the scope and spirit of the present disclosure.
1) For instance, the structure of the elastic dustproof member 50 may be modified in the above embodiments. Specifically, the flexible portion 53 may have a configuration other than a corrugated shape, and the positional relationship between the first frame 51 and the second frame 52 may also be changed.

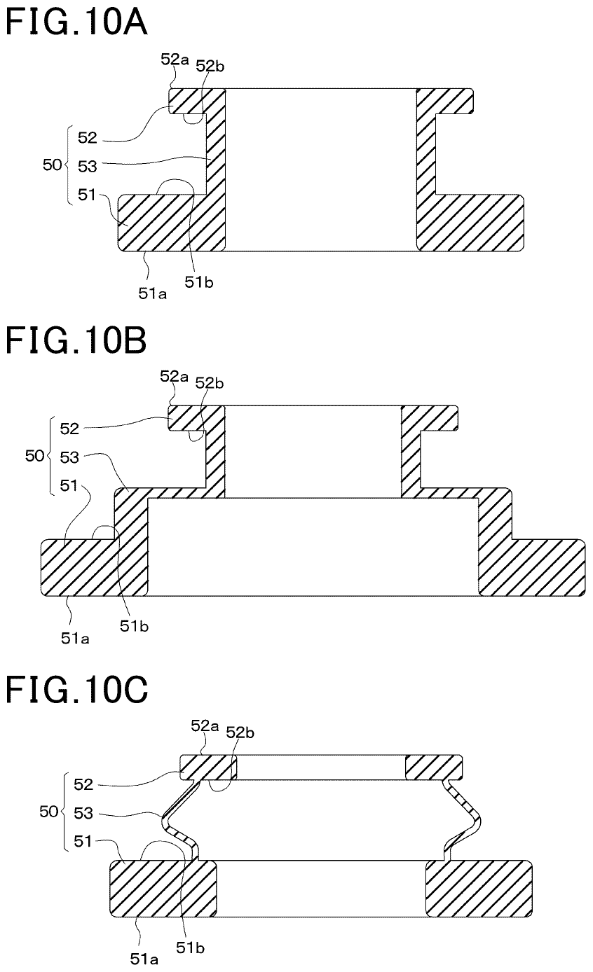

As one example, as shown in FIG. 10A, the flexible portion 53 may have a structure extending linearly along the central axis (CL). Alternatively, the flexible portion 53 may have a bent shape. In this case, as shown in FIG. 10B, when viewed in the front-rear direction (FR), a structure of the elastic dustproof member 50 may be adopted in which a portion of the flexible portion 53 leading to the first frame 51 extends radially outward relative to a portion of the flexible portion 53 leading to the second frame 52, or conversely, extends radially inward. Furthermore, in the above embodiments, when the elastic dustproof member 50 is viewed in the front-rear direction (FR), the entire width dimension (W2) of the second frame 52 is included within the width dimension (W1) of the first frame 51. However, the first frame 51 and the second frame 52 may be offset from each other. In such a case, as shown in FIG. 10C, when viewed in the front-rear direction (FR), the second frame 52 may be positioned radially inward of the first frame 51, or conversely, radially outward of the first frame 51.
2) The above embodiments have referred to a case in which the shapes of the first frame 51 and the second frame 52 are identical with each other, that is, both are annular or rectangular. However, the shapes do not necessarily have to be identical. For example, one of the first frame 51 and the second frame 52 may be annular while the other may be rectangular, and the flexible portion 53 may have a structure in which its shape gradually changes from that of the first frame 51 to that of the second frame 52 as it extends from the first frame 51 toward the second frame 52.
3) In the above embodiments, the shape of the elastic dustproof member 50, as viewed in the front-rear direction (FR), has been described as being annular or rectangular. However, it may instead have another polygonal shape, or a shape in which an arcuate portion and a polygonal portion are combined. In other words, the elastic dustproof member 50 may be formed not only in a cylindrical shape but also in a polygonal tubular shape.
4) In the foregoing embodiments, the imaging device 1 has been described as being applied to a forward monitoring camera for a vehicle. However, the imaging device 1 is not limited thereto and may also be applied to a surrounding monitoring camera configured to monitor an area surrounding the vehicle.
5) Furthermore, in the above embodiments, the present disclosure has been described as being applied to the imaging device 1. However, it may also be applied to other electronic devices. For example, in an electronic device having an optical path extending from a receiving window, through which light or a laser is introduced, to a light-receiving element, the elastic dustproof member 50 may be disposed so as to surround the light-receiving element and the receiving window, thereby suppressing adhesion of foreign matter within the optical path inside the elastic dustproof member 50.

This disclosure provides the following technical aspects.

### FIRST ASPECT

An imaging device for installation in a vehicle which comprises a camera module (10) which includes (a) a lens barrel (20), a substrate (30), a case (40), and an elastic dustproof member (50). The lens barrel includes a main body (21) in which a lens (LS) is disposed and a protrusion (22) which is formed on an outer periphery of the main body and protrudes away from a center of the lens. The main body has formed therein a through-hole (213) through which light, as passing through the lens, travels. The substrate (30) has an imager (31) mounted thereon. The case (40) has formed therein a hole (411) in which the main body of the lens barrel is disposed. The case includes a base portion (41) to which the protrusion of the lens barrel is secured around the main body and the insertion hole. The case defines a housing chamber (54) in which the substrate is retained. The elastic dustproof member (50) is arranged between the base portion and the substrate and isolates a first space (54a), which is defined within the housing chamber and in which the imager and the through-hole are located, from a second space (54b) which is defined outside the first space. The elastic dustproof member has a cylindrical shape and includes a first frame (51), a second frame (52), and a flexible portion (53). The first frame is located closer to the base portion than the second frame is. The second frame is placed in contact with the substrate. The flexible portion connects with the first frame and the second frame and is elastically deformable to change an interval between the first frame and the second frame. The center line of a cylindrical portion of the lens barrel which constitutes an inner wall is defined as a central axis (CL). Dimensions of the first frame and the second frame in directions, which are perpendicular both to the central axis and to extending directions of the first frame and the second frame, are defined as a first width dimension (W1) and a second width dimension (W2), respectively. The second width dimension is smaller than the first width dimension.

### SECOND ASPECT

The imaging device as set forth in the above-described first aspect, wherein the flexible portion has a cross section, as taken in a radial direction oriented from the central axis, which has a V-shaped wave form.

### THIRD ASPECT

The imaging device as set forth in the above-described first or second aspect, wherein the base portion has an end surface (41a) which is located outside the housing chamber and to which the protrusion is secured. The base portion has a seating surface (41c) which is located inside the housing chamber. The first frame has a first contact surface (51a) placed in contact with the seating surface. The second frame has a second contact surface (52a) placed in contact with the substrate.

### FOURTH ASPECT

The imaging device as set forth in the above-described first or second aspect, wherein the base portion has a seating surface (41c) which is located inside the housing chamber. The protrusion is secured to the seating surface of the base portion. The first frame has a first contact surface (51a) placed in contact with the protrusion. The second frame has a second contact surface (52a) placed in contact with the substrate.

### FIFTH ASPECT

The imaging device as set forth in the above-described third or fourth aspect, wherein the second contact surface is shaped to extend radially outward from the flexible portion, in a direction away from the central axis.

### SIXTH ASPECT

The imaging device as set forth in any one of the above-described first to fifth aspects, wherein the elastic dustproof member has a cylindrical shape.

### SEVENTH ASPECT

The imaging device as set forth in any one of the above-described first to fifth aspects, wherein the elastic dustproof member has a polygonal tubular shape.

### EIGHTH ASPECT

The imaging device as set forth in any one of the first to seventh aspects, wherein the second width dimension is equal to or greater than half of an amount of deflection (S) of the elastic dustproof member before and after the elastic dustproof member is installed between the base portion and the substrate.

### NINTH ASPECT

An elastic dustproof member for use with an imaging device installed in a vehicle comprises: (a) a first frame (51) which is located at a first end portion of a cylindrical shape of the elastic dustproof member; (b) a second frame (52) which is located at a second end portion of the cylindrical shape of the elastic dustproof member; and (c) a flexible portion (53) which connects with the first frame and the second frame and is elastically deformable to change an interval between the first frame and the second frame. Dimensions of the first frame and the second frame in directions, which are perpendicular both to an expansion/contraction direction of the flexible portion and to extending directions of the first frame and the second frame, are defined as a first width dimension (W1) and a second width dimension (W2), respectively. The second width dimension is smaller than the first width dimension.

1. An imaging device for installation in a vehicle comprising:
a camera module which includes,
(a) a lens barrel which includes a main body in which a lens is disposed and a protrusion which is formed on an outer periphery of the main body and protrudes away from a center of the lens, the main body has formed therein a through-hole through which light, as passing through the lens, travels,
(b) a substrate on which an imager is mounted,
(c) a case which has formed therein a hole in which the main body of the lens barrel is disposed, the case including a base portion to which the protrusion of the lens barrel is secured around the main body and the insertion hole, the case defining a housing chamber in which the substrate is retained, and
(d) an elastic dustproof member which is arranged between the base portion and the substrate and isolates a first space, which is defined within the housing chamber and in which the imager and the through-hole are located, from a second space which is defined outside the first space, wherein,
the elastic dustproof member has a cylindrical shape and includes a first frame, a second frame, and a flexible portion, the first frame being located closer to the base portion than the second frame is, the second frame being placed in contact with the substrate, the flexible portion connecting with the first frame and the second frame and being elastically deformable to change an interval between the first frame and the second frame, and
a center line of a cylindrical portion of the lens barrel which constitutes an inner wall is defined as a central axis, dimensions of the first frame and the second frame in directions, which are perpendicular both to the central axis and to extending directions of the first frame and the second frame, are defined as a first width dimension and a second width dimension, respectively, the second width dimension being smaller than the first width dimension.

2. The imaging device as set forth in claim 1, wherein the flexible portion has a cross section, as taken in a radial direction oriented from the central axis, which has a V-shaped wave form.

3. The imaging device as set forth in claim 1, wherein the base portion has an end surface which is located outside the housing chamber and to which the protrusion is secured,
the base portion has a seating surface which is located inside the housing chamber, the first frame having a first contact surface placed in contact with the seating surface, and
the second frame has a second contact surface placed in contact with the substrate.

4. imaging device as set forth in claim 1, wherein the base portion has a seating surface which is located inside the housing chamber,
the protrusion is secured to the seating surface of the base portion,
the first frame having a first contact surface placed in contact with the protrusion, and
the second frame has a second contact surface placed in contact with the substrate.

5. The imaging device as set forth in claim 3, wherein the second contact surface is shaped to extend radially outward from the flexible portion, in a direction away from the central axis.

6. The imaging device as set forth in claim 1, wherein the elastic dustproof member has a cylindrical shape.

7. The imaging device as set forth in claim 1, wherein the elastic dustproof member has a polygonal tubular shape.

8. The imaging device as set forth in claim 1, wherein the second width dimension is equal to or greater than half of an amount of deflection of the elastic dustproof member before and after the elastic dustproof member is installed between the base portion and the substrate.

9. An elastic dustproof member for use with an imaging device installed in a vehicle comprising:
a first frame which is located at a first end portion of a cylindrical shape of the elastic dustproof member;
a second frame which is located at a second end portion of the cylindrical shape of the elastic dustproof member; and
a flexible portion which connects with the first frame and the second frame and is elastically deformable to change an interval between the first frame and the second frame, wherein
dimensions of the first frame and the second frame in directions, which are perpendicular both to an expansion/contraction direction of the flexible portion and to extending directions of the first frame and the second frame, are defined as a first width dimension and a second width dimension, respectively, the second width dimension being smaller than the first width dimension.
